(19) United States
(12) Patent Application Publication
(10) Pub. No.: US 2023/0261540 A1
(43) Pub. Date: Aug. 17, 2023

(54) ENCLOSURE FOR A GENERATOR SET SYSTEM

(71) Applicant: NexTier Completion Solutions Inc., Houston, TX (US)

(72) Inventors: Brian K. PARR, Houston, TX (US); Ed BRUNSON, Houston, TX (US)

(21) Appl. No.: 18/168,900

(22) Filed: Feb. 14, 2023

Related U.S. Application Data
(60) Provisional application No. 63/310,368, filed on Feb. 15, 2022.

(51) Int. Cl. H02K 5/10; H02K 7/18

(52) U.S. Cl. CPC H02K 5/10; H02K 7/1815

(57) ABSTRACT

An enclosure assembly is provided to house an engine of a generator set system. The enclosure assembly includes an enclosure having a plurality of walls. The engine is disposed in an interior space defined by the plurality of walls. A chamber disposed in the interior space of the enclosure includes a vent port in fluid communication with an exterior of the enclosure and an intake port for communication with an intake of the engine. In one example, the chamber is closed from fluid communication with the interior space of the enclosure.

### CROSS-REFERENCE TO RELATED APPLICATIONS

This application claims the benefit of U.S. Provisional Application Ser. No. 63/310,368, filed on Feb. 15, 2022, which application is incorporated herein by in its entirety.

### BACKGROUND

### Field

Embodiments of the present disclosure relate an enclosure for a generator set system.

### Description of the Related Art

Generator sets (“gensets”) have been used extensively for power generation. The genset is often portable so can be function as a portable power source at various locations. In general, the genset is a combination of a prime mover, such as an engine, and an alternator. The engine converts the chemical energy of a fuel to mechanical energy. The alternator converts the mechanical energy to useable electrical energy. An alternator is made of two main parts; a rotor and stator. Spinning the alternator rotor through the magnetic field between the rotor and stator creates a voltage on the alternator stator. When the voltage on the stator is connected to a load, electrical current flows, and the generator produces power.

Gensets may include an enclosure to protect its components from the environment. For enclosed gas reciprocating gensets, air intake typically occurs from inside the enclosure. The air inside the enclosure is exposed to heat radiating from the engine, the exhaust, and the alternator. The heat increases the temperature of the air inside the enclosure. The increased temperature of the air intake can lower the performance of the engine, or in severe cases, cause the engine to shut down due to high air intake temperatures.

There is a need, therefore, for an improved intake for a genset enclosure.

### BRIEF DESCRIPTION OF THE DRAWINGS

So that the manner in which the above recited features of the present disclosure are attained and can be understood in detail, a more particular description of the disclosure, briefly summarized above, may be had by reference to the drawings that follow. The drawings illustrate only selected embodiments of this disclosure, and are not to be considered limiting of its scope.

FIG. 1 is a perspective view of the genset assembly and an enclosure assembly according to one embodiment. FIG. 1 shows the enclosure assembly with some of the doors and louvers removed.

FIG. 2 shows the genset assembly and the enclosure assembly with the roof removed.

FIG. 3 is a perspective view of the enclosure assembly with the roof removed.

FIG. 4 is a different perspective view of the enclosure assembly with some louvers removed.

FIG. 5 is a partial schematic view of the enclosure assembly and some of the components of the genset assembly.

FIG. 6 is an enlarged, partial view of the enclosure assembly including an intake chamber.

### DETAILED DESCRIPTION

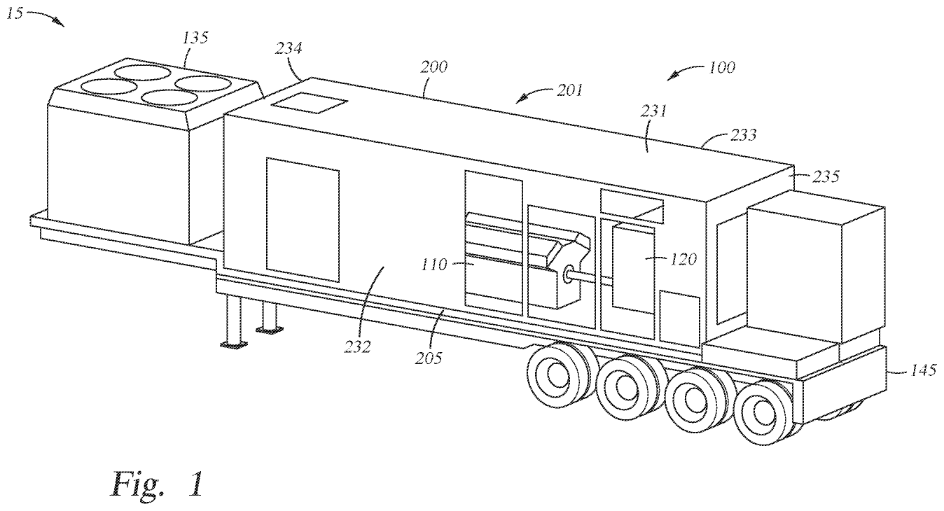

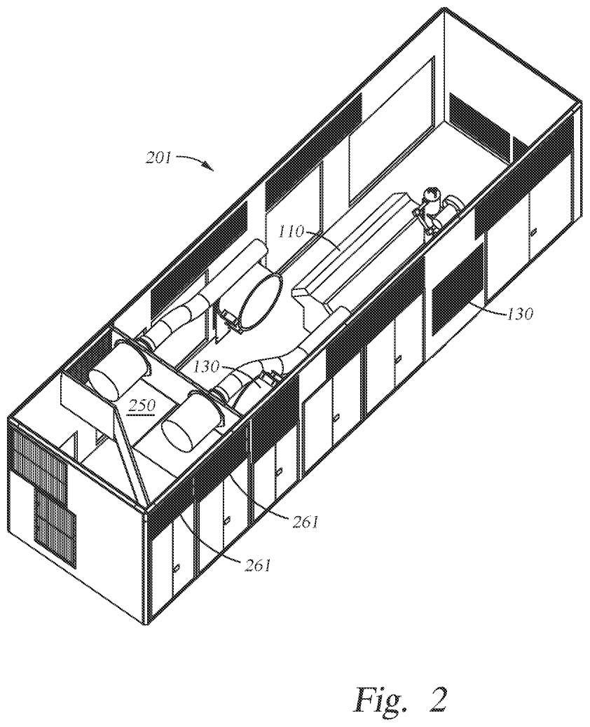

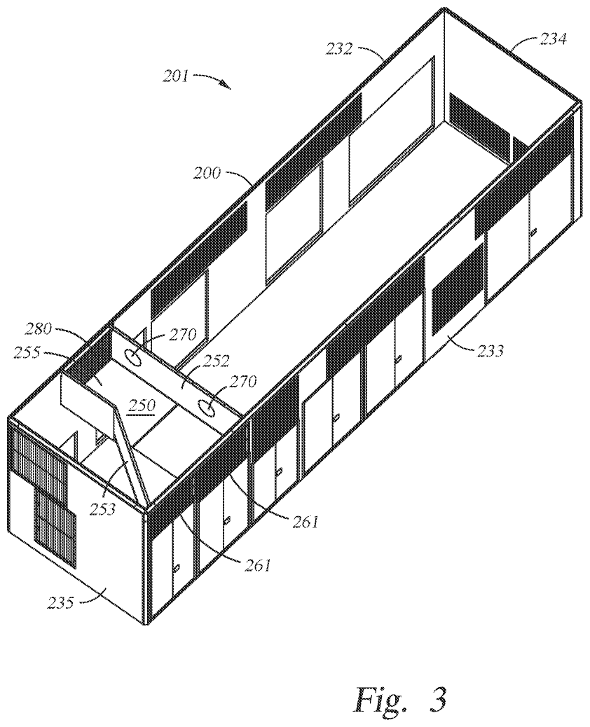

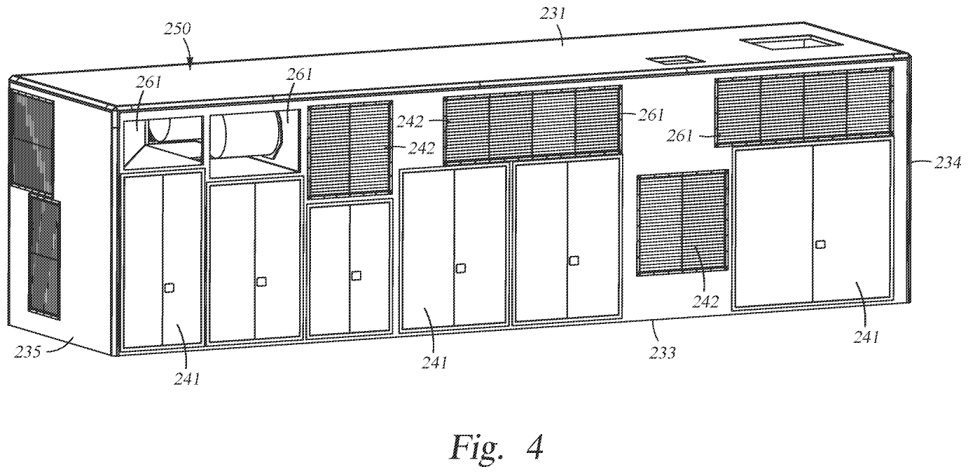

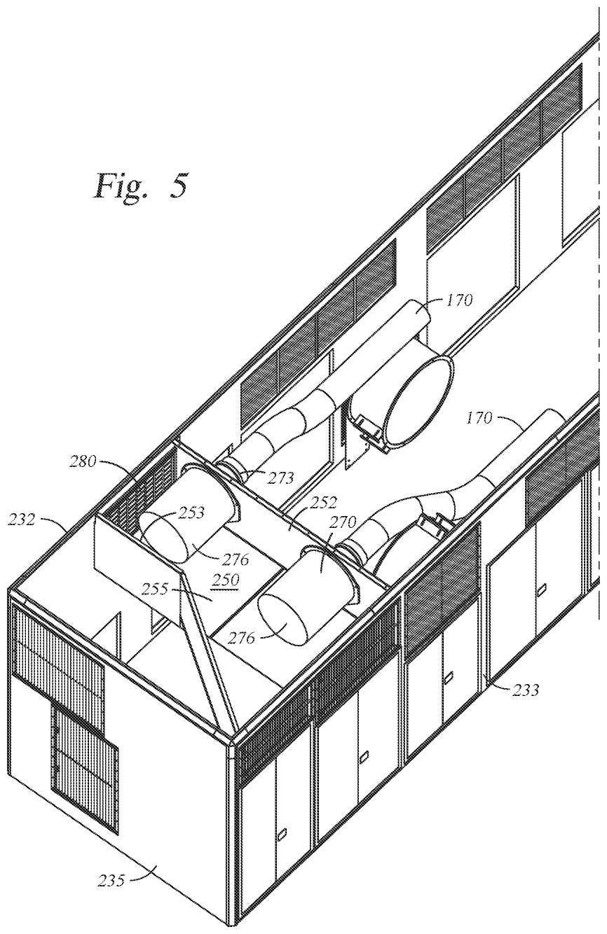

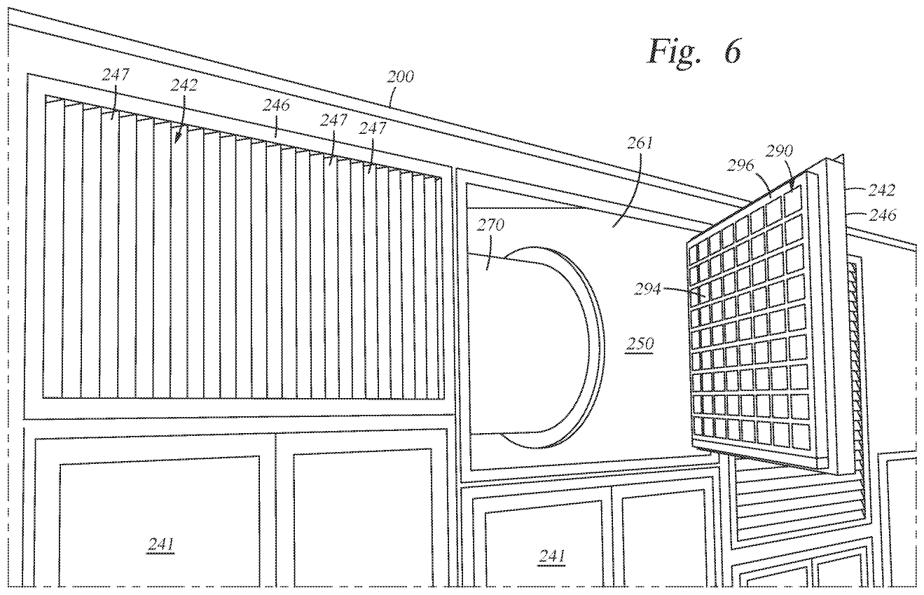

FIGS. 1 to 5 are different views of a genset system 15 according to one embodiment. The genset system 15 includes a genset assembly 100 and an enclosure assembly 201. FIG. 1 is a perspective view of the genset system 15. FIG. 1 shows the enclosure assembly 201 with some of the doors and louvers removed. FIG. 2 shows the genset assembly 100 and the enclosure assembly 201 with the roof removed. FIG. 3 is a perspective view of the enclosure assembly with the roof removed. FIG. 4 is a different perspective view of the enclosure assembly with some louvers removed. FIG. 5 is a partial schematic view of the enclosure assembly 201 and some of the components of the genset assembly 100. FIG. 6 is an enlarged, partial view of the enclosure assembly 201 including an intake chamber 250.

Referring to FIGS. 1 and 2, the genset assembly 100 includes an engine 110, a generator 120 and an exhaust fan 130. The engine 110 may include an internal combustion (IC) engine that converts fuel into mechanical energy. Exemplary engines include a diesel engine, a gasoline engine, a natural gas engine, a dual fuel engine, an ethanol engine, and a biodiesel engine. Exemplary fuels include diesel, gasoline, natural gas, and ethanol. Combustion of fuel by the engine 110 produces an exhaust gas. In some embodiments, the exhaust gas may be treated before expelling into the environment by one or more exhaust fans 130. In some embodiments, an exhaust treatment system may be fluidly coupled to the engine and configured to treat the exhaust gas. The exhaust treatment system may be positioned within the enclosure assembly 201. The engine 110 may be either air cooled or liquid cooled, and have a radiator 135 positioned within the air flow path.

The generator 120 is operatively coupled to the engine 110 via a genset shaft. For example, the genset shaft may include a crankshaft of the engine 110 coupled to a generator shaft of the generator 120. The generator 120 may include a wound rotor or permanent magnet alternator configured to convert a rotational mechanical power produced by the engine 110 into electrical energy as a direct current (DC) or synchronous alternating current (AC) generator. In some embodiments, an inverter can also be electrically coupled to the generator 120, and the genset assembly 100 may be variable speed. The generator 120 is configured to produce an electrical output. The electrical output can include a voltage and/or a current, and is representative of a load on the engine 110. For example, the electrical output can correspond to the engine 110 power (e.g., power=voltage x current). In some embodiments, the electrical output from the generator 120 can be converted or inverted to transform the electrical output from a variable AC or a direct current (DC) to a synchronous alternating current (AC).

The genset assembly 100 may be disposed within the enclosure assembly 201. In one embodiment, the enclosure assembly 201 includes an enclosure 200 coupled to a base 205. For example, the engine 110, the generator 120, and the exhaust fan 130 can be positioned on the base 205, and the enclosure 200 can be positioned on the base 205 around the engine 110, the generator 120, and the exhaust fan 130. In one embodiment, the base 205 may be disposed on a trailer 145 for transport. In another embodiment, the base 205 may be integral with the trailer 145. In one embodiment, the trailer attaches to a truck at a front end and includes wheels at a back end. In some embodiments, the genset assembly 100 includes a radiator that is disposed on the base, but exterior to the enclosure 200.

The enclosure 200 is configured to protect the components of the genset assembly 100 from the environment, for example rain, wind, and sunlight. The enclosure 200 may be formed from a suitable rigid material such as metal, plastic, or both. Referring to FIGS. 1, 3, and 4, the enclosure 200 includes a roof 231, two sidewalls 232, 233, and two end walls 234, 235. In this example, the walls 231-235 form a rectangular enclosure that is open at the bottom. The bottom of the enclosure 200 is attached to the base 205 to close the enclosure 200. The walls define an interior space sufficient to accommodate the engine 110 and the generator 120. Each of the walls 231-235 may have one or more openings 261 formed therethrough. As shown in FIG. 4, some of the openings 261 may be provided with doors 241 for access to the interior of the enclosure 200. Some of the openings 261 may be provided with louvers 242 for fluid communication between the interior and the exterior of the enclosure 200. The louvers 242 may be configured to prevent objects from entering the enclosure 200.

In one embodiment, the enclosure assembly 201 includes an intake chamber 250 in fluid communication with the intake of the engine 110. In one example, the chamber 250 includes a vent port 280 for fluid communication with the exterior of the enclosure 200 and an intake port 270 for fluid communication with the intake 170 of the engine 110. As shown in FIGS. 3, 4, and 5, the intake chamber 250 is disposed within the enclosure 200. In some embodiments, the intake chamber 250 is isolated from fluid communication with the interior of the enclosure 200. In this example, the chamber 250 includes a floor 255, chamber walls 252, 253, and a roof. The roof of the chamber 250 is also the roof 231 of the enclosure 200. However, it must be noted the chamber 250 may have a roof that is separate from the roof 231 of the enclosure 200. Although the chamber 250 is shown with four walls 231, 252, 253, 255, it is contemplated the chamber 250 can include any suitable number of walls. The floor 255 and the chamber walls 252, 253 extend from one sidewall 232 to the other sidewall 233 of the enclosure 200. The ends of the chamber 250 are open for fluid communication with the exterior of the enclosure 200 via the openings 261 in the sidewalls 232, 233. In this respect, the openings 261 in the sidewalls 232, 233 function as the vent ports 280 of the chamber 250. As shown in FIG. 3, one of the sidewalls 253 is angled such that the two ends of the chamber 250 have different sizes. One end of the chamber 250 is sized to match one opening 261 in side wall 232 of the enclosure 200, and the other end of the chamber 250 is sized to match two openings 261 in side wall 233. In some embodiments, the openings 261 in the side walls 232, 233 may have the same or different sizes. In some embodiments, the two ends of the chamber 250 may have the same or different sizes. In some embodiments still, the size of the ends may be altered by changing the dimensions of one or more of the walls of the chambers 250. In some embodiments, the chamber 250 includes an end wall that closes off one end (e.g., opening 261) of the chamber 250. In some embodiments, the end wall can have a vent port that is smaller than the size of the end wall or opening 261 in the sidewalls 232, 233. In some embodiments, the vent ports 280 may be formed in other locations of the chamber 250 for fluid communication between the exterior and the interior of the chamber 250. For example, a vent port can be formed in the roof of the chamber 250 and can communicate with an opening in the roof of the enclosure 200. In another example, the roof has one or more vent ports, and one or both ends of the chamber 250 are closed from fluid communication. In some embodiments, the chamber 250 may have any suitable number of vent ports for fluid communication with the exterior of the enclosure 200, and the chamber 250 is closed from fluid communication with the interior of the enclosure 200. In some embodiments, the chamber 250 is hermetically sealed against the interior of the enclosure 200.

Referring to FIGS. 3-6, the chamber 250 includes one or more intake ports 270 for fluid communication with the intake 170 of the engine 110. As shown, the chamber 250 has two intake ports 270 for fluid communication with two intakes 170. However, it is contemplated the genset assembly 100 may have one intake 170 or three or more intakes 170. In this embodiment, the intake ports 270 are formed in the sidewall 252 of the chamber 250. However, it is contemplated the intake ports 270 may be located at any suitable location, such as in the floor 255 of the chamber 250. In some embodiments, the sum of the area of the vent ports 280 is the same or larger than the sum of the area of the intake ports 270. In some embodiments, a connector plate 273 may be used to facilitate connection of the tubular shaped intake 170 to the intake ports 270. The connection of the intake 170 to the chamber 250 may be sealed against fluid communication with the exterior of the chamber 250. In this manner, the intake 170 may draw air from inside the chamber 250, which in turn, has entered into the chamber 250 from the exterior of the enclosure 200 via the vent ports, such as the open ends, of the chamber 250. Thus, the chamber 250 advantageously provides the intake 170 with outside air that is at a lower temperature than the air inside the interior space of the enclosure 200.

In some embodiments, an air filter 276 is mounted to each intake port 270 to block out unwanted objects from entering the intake 170. As shown in FIG. 5, the air filter 276 is connected to the inlet of the intake 170 and is located inside the chamber 250. Exemplary air filters 276 include any suitable air filter configured for use with an intake 170 of the engine 110.

In one embodiment, a louver 242 is attached to the openings 261 in the enclosure 200 that communicate with the intake chamber 250. The louvers 242 may pivotally attached to the enclosure 200, such as via a hinge. The louvers 242 may be configured to block out unwanted objects from entering the chamber 250. In some embodiments, the louvers 242 and the air filters 276 may be configured to block out different ranges of sizes of the objects, which ranges may overlap. In one embodiment, the louvers 242 include a louver frame 246 and a plurality of blades 247 disposed within the frame 246. Optionally, the blades 247 are pivotable relative to the frame 246 to adjust the space between adjacent blades 247.

In some embodiments, a secondary filter 290 is provided in the openings 261. For example, a filter frame 296 can be attached to the interior side of the louver frame 246. A filter material 294 is disposed in a space defined between the filter frame 296 and the louver frame 246. The filter material 294 may be configured to block out objects that pass between the blades 247 of the louver 242. In some embodiments, the filter material 294 can be removed and cleaned and/or replaced. The louver 242 can pivot open for accessing the filter material 294 disposed behind the louver 242. In some embodiments, the secondary filter 290 is attached to the enclosure 200. In some embodiments, the second filter 290 is attached the chamber 250.

In some embodiments, an enclosure assembly for a generator set system having an engine includes an enclosure having a plurality of walls and an interior space defined by the plurality of walls, the interior space configured to accommodate the engine. A chamber is disposed in the interior space of the enclosure. The chamber has a vent port in fluid communication with an exterior of the enclosure and an intake port for communication with an intake of the engine, The chamber is closed from fluid communication with the interior space of the enclosure.

In some embodiments, the enclosure assembly includes an air filter attached to the intake port.

In some embodiments, the air filter is disposed in the chamber.

In some embodiments, the intake port is formed in a wall of the chamber.

In some embodiments, the vent port fluidly communicates with the exterior via an opening formed in one of the plurality of walls of the enclosure.

In some embodiments, the chamber includes two vent ports.

In some embodiments, each of the vent ports communicate with a respective opening in the enclosure.

In some embodiments, the size of the two vent ports are different.

In some embodiments, the enclosure assembly includes a louver for controlling fluid communication through the opening in the enclosure.

In some embodiments, the enclosure assembly includes a secondary filter for controlling fluid communication through the opening in the enclosure.

In some embodiments, the secondary filter is attached to the louver and movable with the louver.

In some embodiments, the secondary filter and the louver are configured to prevent foreign objects having different sizes from entering the chamber.

In some embodiments, the enclosure includes two sidewalls connected to two end walls and a roof connected to the two sidewall and the two end walls.

In some embodiments, the chamber includes two sidewalls connected to the two sidewalls of the enclosure.

In some embodiments, the chamber includes a floor connected to the two sidewalls of the enclosure.

In some embodiments, the two sidewalls of the chamber are connected to the roof of the enclosure.

In some embodiments, a generator set system includes an engine having an intake and a generator operatively coupled to the engine. The system also includes an enclosure having a plurality of walls and an interior space defined by the plurality of walls. The interior space is configured to accommodate the engine and the generator. A chamber is disposed in the interior space of the enclosure. The chamber has a vent port in fluid communication with an exterior of the enclosure and an intake port for communication with the intake of the engine. The chamber is closed from fluid communication with the interior space of the enclosure.

In some embodiments, the system includes an air filter attached to the intake port and disposed in the chamber.

In some embodiments, the intake port is formed in a wall of the chamber.

In some embodiments, the vent port fluidly communicates with the exterior of the enclosure via an opening formed in one of the walls of the enclosure.

In some embodiments, the chamber includes two vent ports, and each of the vent ports communicate with a respective opening in the enclosure.

In some embodiments, the openings are located on different walls of the enclosure.

In some embodiments, the system includes a louver for controlling fluid communication through the opening in the enclosure.

In some embodiments, the system includes a secondary filter for controlling fluid communication through the opening in the enclosure.

In some embodiments, the secondary filter is attached to the louver and movable with the louver.

In some embodiments, the secondary filter and the louver are configured to prevent foreign objects having different sizes from entering the chamber.

In some embodiments, the system includes a base for supporting the engine and the generator, wherein the base is attached to the bottom of the enclosure.

While the foregoing is directed to embodiments of the present disclosure, other and further embodiments of the disclosure may be devised without departing from the basic scope thereof, and the scope thereof is determined by the claims that follow.

1. An enclosure assembly for a generator set system having an engine, comprising:
an enclosure having a plurality of walls;
an interior space defined by the plurality of walls, the interior space configured to accommodate the engine; and
a chamber disposed in the interior space of the enclosure, the chamber having a vent port in fluid communication with an exterior of the enclosure and an intake port for communication with an intake of the engine,
wherein the chamber is closed from fluid communication with the interior space of the enclosure.

2. The enclosure assembly of claim 1, further comprising an air filter attached to the intake port.

3. The enclosure assembly of claim 2, wherein the air filter is disposed in the chamber.

4. The enclosure assembly of claim 1, wherein the intake port is formed in a wall of the chamber.

5. The enclosure assembly of claim 1, wherein the vent port fluidly communicates with the exterior via an opening formed in one of the plurality of walls of the enclosure.

6. The enclosure assembly of claim 5, wherein the chamber includes two vent ports.

7. The enclosure assembly of claim 6, wherein each of the vent ports communicate with a respective opening in the enclosure.

8. The enclosure assembly of claim 7, wherein the size of the two vent ports are different.

9. The enclosure assembly of claim 5, further comprising a louver for controlling fluid communication through the opening in the enclosure.

10. The enclosure assembly of claim 9, further comprising a secondary filter for controlling fluid communication through the opening in the enclosure.

11. The enclosure assembly of claim 10, wherein the secondary filter is attached to the louver and movable with the louver.

12. The enclosure assembly of claim 11, wherein the secondary filter and the louver are configured to prevent foreign objects having different sizes from entering the chamber.

13. The enclosure assembly of claim 1, wherein the enclosure includes:
two sidewalls connected to two end walls; and
a roof connected to the two sidewall and the two end walls.

14. A generator set system, comprising:
an engine having an intake;
a generator operatively coupled to the engine;
an enclosure having a plurality of walls;
an interior space defined by the plurality of walls, the interior space configured to accommodate the engine and the generator; and
a chamber disposed in the interior space of the enclosure, the chamber having a vent port in fluid communication with an exterior of the enclosure and an intake port for communication with the intake of the engine,
wherein the chamber is closed from fluid communication with the interior space of the enclosure.

15. The generator set of claim 14, further comprising an air filter attached to the intake port and disposed in the chamber.

16. The generator set of claim 14, wherein the intake port is formed in a wall of the chamber.

17. The generator set of claim 14, wherein the vent port fluidly communicates with the exterior of the enclosure via an opening formed in one of the walls of the enclosure.

18. The generator set of claim 17, wherein the chamber includes two vent ports, and each of the vent ports communicate with a respective opening in the enclosure.

19. The generator set of claim 18, the openings are located in different walls of the enclosure.

20. The generator set of claim 17, further comprising a louver for controlling fluid communication through the opening in the enclosure.
